(19) United States
(12) Patent Application Publication
(10) Pub. No.: US 2007/0104831 A1
(43) Pub. Date: May 10, 2007

(54) Fermented wine made from fruits of araliaceous shrubs, and method for production thereof

(76) Inventor: Dae Sung Choi, Kangweon-do (KR)

Correspondence Address: STAAS & HALSEY LLP, SUITE 700, 1201 NEW YORK AVENUE, N.W., WASHINGTON, DC, 20005, US

(21) Appl. No.: 10/551,441

(22) PCT Filed: Feb. 10, 2004
(86) PCT No.: PCT/KR04/00253

§ 371 Date: Nov. 20, 2006

(30) Foreign Application Priority Data
Apr. 8, 2003 (KR) 10-2003-0021930
Dec. 24, 2003 (KR) 10-2003-0096224

(51) Int. Cl. C12C 11/00

(52) U.S. Cl. 426/11

(57) ABSTRACT

Fermented wines made from fruits of deciduous shrubs or latifoliate shrubs in the family of Aralia elata, especially, fruits of Acanthopanax sessiliflorous or Acanthopanax senticosus, and a producing method thereof. These fermented wines are much milder than traditional liquors made from roots or stems of Acanthopanax. The method of utilizing fruits of Acanthopanax, that otherwise have traditionally been discarded, results in increased economic benefit by helping increase usage of farm yields.

### TECHNICAL FIELD

The present invention relates to fermented wine made from fruits of dicotyledonous deciduous shrub or latifoliate shrub in the family Araliaelata, particularly to fermented wine made from fruits of Acanthopanax sessiliflorus or Eleutherococcus senticosus as main material and a process for preparation thereof.

### BACKGROUND

Acanthopanax sessiliflorus and Acanthopanax senticosus (or Eleutherococcus senticosus) are deciduous and broadleaf shrubs in the family Araliaelata like ginseng. Especially, Acanthpanax senticosus resembles the wild ginseng in the shape and is also called as Siberian ginseng in Russia, America and Europe. Acanthopanax sessiliflorus and Acanthopanax senticosus are distributed around Baekdu mountain in North Korea covering Manchuria, Maritime Province of Siberia, alpine belts of Korea and the northeast region of Hokkaido, Japan. Often, they may grow wildly in the restricted area including Asian countries over 40° north latitude or hilly area over 600˜1,000 m above the sea level.

The Acanthopanax sp. shrub attracts global attention as a novel medicinal herb, since it has no toxicity in the whole tree and also has the broad range of pharmaceutical efficacy. In the Olympic Games, the players of the old Soviet Union have increased records after administering Acanthopanax sp. herb. In 1986, it is also disclosed in the scientific journal, New Scientist that a number of people including explorer, astronomer, soldier and the like often took Acanthopanax sp. to enhance the physical strength and the intensive power highly. Therefore, Acanthopanax sessiliflorus and Acanthopanax senticosus become a public concern on account of these effects.

Acanthopanax sessiliflorus or Acanthopanax senticosus has been already elucidated to contain acanthosides having the most outstanding activity biologically and other useful constituents.

For a long time, Acanthopanax sessiliflorus or Acanthopanax senticosus has been known as an herbal plant to improve the personal health and investigated in various aspects regarding its constituents and efficacies. These herbs are identified by such a research to affect the congenital and specific immune system in the living body of human being and to enhance the anti-bacterial activity and the anti-tumor activity.

In addition, Acanthopanax sessiliflorus and Acanthopanax senticosus include not only glycosides such as Acanthoside B and D and soluble polysacchrides enhancing the immunity in a large amount, but also Sylrgin, cumarin and the like as a glycoside in their roots. The above-mentioned Acanthosides are illustrated to have a remarkable effect upon the hematosis of bone marrow, since they may stimulate the RNA synthesis. The soluble polysaccharides have been demonstrated to promote the leukocyte because they may increase the number of macrophage.

Hence, Acanthopanax sessiliflorus and Acanthopanax senticosus can activate the function of living body and be effective upon autoimmune diseases. They are also a good restorative if administered for the patient lacking in spirit and energy.

On the other hand, Acanthopanax sessiliflorus and Acanthopanax senticosus are collected in the period between summer and autumn and dried in roots and barks, which is called as “Ogapi” or “Ogalpi”. “Ogapi” has been used for a sort of medicine in ancient times and is known to treat the stroke or the weak constitution traditionally as Oriental medicine, since it contains various components advantageous for human being as described above.

Furthermore, Ogapi can be a material to manufacture wine and these wines are referred to as “Ogapi wine” or “Ogalpi wine”.

Precisely, the root coat and the bark (namely “Ogapi”) derived from Acanthopanax sessiliflorus and Acanthopanax senticosus tree are well washed by using water, dried, cut to pieces in 2˜3 cm of size, poured into a container, soaked by adding liquor and sugar and fermented. Then, the container is stored at cool temperature for about 1˜3 months to extrude effective components of Ogapi by alcohol. For a long time, Ogapi wine manufactured by the above-mentioned procedure has been an invigorant and is reported to be highly effective on lumbago, numbness in hands and feet, hemiplegia and the like.

Recently, some processes of preparation functional beverages and alcohols have been developed by using a tree such as Acanthopanax sessiliflorus and Acanthopanax senticosus. In detail, it is disclosed in Korean Patent Application Laid-open No. 1999-001026 that the sport drink for replenishing water and electrolytes can be manufactured to add Acanthopanax sp. extract to existed beverage. In Korean Patent Application Laid-open No. 2002-24775, the process for producing liquor is also demonstrated, which comprises steps: (A) extracting Oriental herbes such as Acanthopanax sessiliflorus by using the mixture of sugar and citric acid; and (B) mixing alcohol and distilled water, filtrating and fermenting under Commercial Code.

Meanwhile, it is identified that Acanthoside D is found in a large amount from fruits of Acanthopanax sessiliflorus and Acanthopanax senticosus, although it is reported to be mostly included in roots. Chiisanoside as a secotriterpenoid glycoside also exist in these fruits even if it often be contained only in leaves of a certain Acanthopanax species. Furthermore, the pharmaceutical efficacy of Chiisanoside is investigated by using MTT analysis for anticancer activity, renal toxicity and the like. It is verified that these fruits contain approximately 10-fold content of glutamate than common crops.

Presently, the roots and barks of Acanthopanax sessiliflorus and Acanthopanax senticosus, so called as “Ogapi” are illustrated to have the traditional effect and use and thus adopted widely, but the fruits of trees are left or discarded in practice.

Hence, it is necessary to explore how to use the fruits of Acanthopanax sessiliflorus and Acanthopanax senticosus efficiently, to exploit various effective constituents and further to find out how to increase the income of farmhouse by using the very fruits.

### DISCLOSURE OF THE INVENTION

The present inventors have observed that Acanthopanax sessiliflorus and Acanthopanax senticosus include several sorts of functional sugars in fruits a lot and attempted to develop novel fermented wine which is distinguished from conventional Ogapi wine prepared by alcohol extraction, has the more outstanding sense to drink by fermenting fruits and can sustain various useful constituents of these fruits.

Therefore, the object of the present invention is to provide fermented wine made from fruits of Acanthopanax sessiliflorus and/or Acanthopanax senticosus.

Another object of the present invention is to provide a process for production of fermented wine made from the fruits of Acanthopanax sessiliflorus and/or Acanthopanax senticosus as main material.

The other object of the present invention is to provide a process for production of fermented wine made from the fruits of Acanthopanax sessiliflorus and/or Acanthopanax senticosus as main material, in which Rosa davurica extract and Rhynchosia nolubilis extract are added to improve the functional property and the product quality of the fermented wine.

In order to attain the above-mentioned objects, the present invention provides fermented wine made from the fruit of deciduous shrub or latifoliate shrub in the family Araliaelata as main material. Preferably, the shrubs in the family Araliaelata are Acanthopanax sessiliflorus and Acanthopanax senticosus.

The present invention provides a process for production of fermented wine, which comprises (A) step for preparation of fermented solution; (B) step for fermentation; and (C) step for stopping the reaction.

In order to improve the functional property and the product quality of fermented wine described above, Rosa davurica Pallas extract and Rhynchosia nolubilis extract can be added before fermentation. Preferably in said step for preparation of fermented solution, the water extract obtained from 0.05˜0.25 kg of Rosa davurica and/or the water extract obtained from 0.05˜0.25 kg of Rhynchosia nolubilis can be added in 1 kg of dry weight of the fruits.

The shrub of Rosa davurica smells good in flowers and is used for source material of perfume. Especially, it is elucidated that the root be highly effective on the cancer treatment and the prevention of aging as well as the leaf and the fruit contain a large amount of vitamin C. Therefore, Rosa davurica is an outstanding herbal plant to prevent and treat adult diseases. It is confirmed in several research institutes including Science Institute of Natural Herbs that Rosa davurica contain 20-fold vitamin C (for example, 1,072 mg per 100 g) in the fruit more than lemon.

Rhynchosia nolubilis is an herb product in the Korean, is edible and has a remarkable efficacy as medicine. From ancient, Rhynchosia nolubilis is called as “drug bean” due to the medicinal use and precisely, it has the highest efficacy among beans, detoxifies strongly, prevents all kinds of diseases and recovers the damage of human tissue rapidly. Especially, Rhynchosia nolubilis is reported in a number of Oriental herb documents to have a medicinal effect on diabetes and to improve the renal function. Recently, it is soaked in vinegar to make a sour bean and taken to prevent and treat constipation and adult diseases. In addition, it is illustrated in the ancient document that the drug bean confers a clear and better eye view when eaten in raw material.

In order to attain the above-mentioned objects, the present invention provides a process for production of fermented wine as follows.

Precisely, above all in (A) step for preparation of fermented solution, 1˜20 L of pure water is added in 1 kg of crude fruit from deciduous shrub or latifoliate shrub in the family Araliaelata and adjusted to 10˜35° Brix by dissolving sugar. Then, in (B) step for fermentation, yeast is inoculated into the fermented solution and fermented at the range of 20˜30° C. After the resulting solution reaches a proper stage of fermentation, (C) step for stopping the fermentation is proceeded. The fermented solution is treated to stop the reaction by adding some chemical agents such as ammonium phosphate or potassium sulfate in a proper amount, or by incubating under a low temperature at the range of 0˜5° C. so as to manufacture the fermented wine of the present invention.

At this moment, if necessary, several additional steps can be performed as follows. In (D) step for filtration, the fermented solution is filtrated after stopping the fermentation and in (E) step for maturation of the fermented solution, the fermented solution filtrated above is maintained to mature under a low temperature at the range of 10˜25° C.

In the present invention, the fermented wine is supposed to have a good sense of beverage in the range of 10˜20% of alcohol content and to ferment approximately 50% of the sugar content. Preferably, the fermented solution is maintained at the range of 20˜30° Brix in the (A) step for preparation of fermented solution. Any kind of sugar can be added if it can be fermented in yeast strains. Preferably, the sugar can be selected among glucose, fructose, sucrose, maltose, glutinous starch syrup, molasses, starch (for example, rice or rice powder) and the like. More preferably, sucrose can be used since it may be purchased and managed conveniently. Also, honey can be used as sugar additive instead of sucrose to improve the functional property, although the experimental data is not depicted.

Preferably in the (C) step for stopping the fermentation, the fermented solution is treated to stop the reaction, when the alcohol concentration reaches 10˜15%.

Preferably in the (A) step for preparation of fermented solution, crude fruit is used in an intact state. Further, the fruit can be reduced to powder before use, used only in the flesh after removing the core of fruit or squeezed to utilize only juice, depending upon requirements.

On the other hand, it costs much to collect and store the natural fruits of Acanthopanax sessiliflorus and Acanthopanax senticosus in an intact state and to transfer the fermented wine already manufactured in factory, since they grow wildly in the mountainous region or are cultivated in remote farms. Therefore, it is recommended that the fruits should be dried (for example, dried in the wind, dried under light, dried under shade, dried by heat, lyophilized or the like), after collected in the mountainous region and utilized to prepare the fermented wine of the present invention. Depending upon requirements, the fruit can be crude fruit in an intact state, further reduced to powder before use, used only in the flesh after removing the core of fruit or be extracted in a dried state by using essential oil.

In the present invention, any yeast strain can be used if it produces alcohol by the fermentation. Preferably, yeast used for grape wine, for bread, for traditional liquor (so called as Nooruk) or the like can be adopted. More preferably, yeast is pre-cultivated in the small aliquot of fermented solution and then, inoculated to the total fermented solution, since yeast may proliferate slowly at the early stage of growth if it is inoculated directly to the total fermented solution, which can delay the fermentation step. In detail, approximately 3˜5 L of the fermented solution is collected from 100 L of the total solution, pre-cultivated for about 24˜48 hours at 30° C. after approximately 0.9˜1.5 g of yeast is inoculated (which is estimated to 0.2˜0.3 g yeast/1 L of the total fermented solution) and again inoculated to the total fermented solution.

### EXAMPLES

Practical and presently preferred embodiments of the present invention are illustrated as shown in the following Examples.

However, it will be appreciated that those skilled in the art, on consideration of this disclosure, may make modifications and improvements within the spirit and scope of the present invention.

It is also natural for those skilled in the art to prepare the fermented liquor of the present invention by exploiting other procedures and methods instead of this procedure in the following Examples.

In the present invention, any fruit derived from Acanthopanax sessiliflorus and Acanthopanax senticosus may give the same products as shown in the experimental data and these two fruit will not be distinguished in following Examples. Therefore, the fruit of Acanthopanax sessiliflorus and the fruit of Acanthopanax senticosus are simply described as “fruit”, “ogapi fruit” or “gasiogapi fruit”.

Besides, it is clear for those skilled in the art that the fruit can be reduced to powder to prepare the fermented liquor of the present invention, depending upon convenience, although only natural fruit or dry fruit is utilized as it is in following Examples. Furthermore, it is natural for those skilled in the art that the natural fruit or the dry fruit can also be treated previously to extract effective constituents, filtrated immediately in the late stage of the (A) step for preparation of fermented solution to exclude the remained fruit and continued to proceed the (B) step of fermentation as follows, even if the fruit is adopted in the (A) step for preparation of fermented solution, proceeded the next steps and filtrated after the fermentation is completed, in following Examples.

### Example 1

### Production of Fermented Wine by Using Crude Fruit as Main Material

In order to prepare the fermented wine of the present invention, crude Ogapi fruit was utilized as it is and not dried.

Above all, the crude fruit of Acanthopanax was washed by using pure water and wiped a little to remove moisture on the surface. To 5 kg of crude fruit, 4.5 L of pure water (9 L of pure water per 1 kg of crude fruit) was added, adjusted to 24° Brix by dissolving sugar and filled to approximately 50 L of fermented solution. (the step for preparation of fermented solution)

3 L of fermented solution prepared above was separated and 15 g of commercially available yeast for bread was inoculated. The culture solution inoculated in the fermented solution was pre-incubated for 24 hours at 30° C. and again inoculated into the whole fermented solution prepared above. The resulting fermented solution was processed at 20˜25° C. to be further fermented (the step for fermentation), and the alcohol concentration in the fermented solution was checked every 24 hours. When the alcohol concentration was over 12.0%, 200 ppm of potassium sulfite per 1 L of the fermented solution was added to the fermented solution in order to stop the reaction (the step for stopping the fermentation).

After stopping the fermentation, the resulting solution was filtrated and purified. As a result, the fermented wine of the present invention made from the crude Ogapi fruit as main material was manufactured.

### Example 2

### Production of Fermented Wine by Using Crude Fruit as Main Material

The fermented wine of the present invention was prepared to contain Rosa davurica and Rhynchosia nolubilis extract.

In dry Rosa davurica, leaves, roots, stems and fruits were washed clear, pulverized and then extracted through water heating for 12˜15 hours at 70˜95° C. after 7-fold water more than the dry weight was added, with the extractor in which a refrigerating condenser was installed to prevent effective components from evaporation. Again, the extract obtained above was filtrated and condensed under reduced pressure to prepare the Rosa davurica extract of the present invention.

Rhynchosia nolubilis was reduced to powder and extracted three times through circulation by using hexane to remove lipid components. Then, the resultant was extracted through water heating for 5 hours at 90° C., repeatedly extracted three times and filtrated. The supernatant obtained above was concentrated under reduced pressure and dried under vacuum to prepare the Rhynchosia nolubilis extract of the present invention.

In the step for preparation of fermented solution described in Example 1, the water extracts were added to 0.15 kg of Rosa davurica and 0.15 kg of Rhynchosia nolubilis per 1 kg of dry weight of the above-mentioned natural fruit and proceeded by using the same procedure as demonstrated in Example 1. As a result, the fermented wine of the present invention made from the crude fruit of Acanthopanax sp. as main material was manufactured.

### Example 3

### Production of Fermented Wine by Using Dry Fruit as Main Material I

In order to prepare the fermented wine of the present invention, dry Ogapi fruit was utilized as raw material.

Above all, the crude fruit of Acanthopanax sp. was dried in the shade to prepare the dry fruit.

Then, the dry fruit was washed by using pure water and wiped off to remove moisture on the surface. To 4 kg of dry fruit, 4.4 L of pure water (11 L of pure water per 1 kg of dry fruit) was added, adjusted to 24° Brix by dissolving sugar and filled to approximately 45 L of fermented solution. (the step for preparation of fermented solution)

The same procedure was performed as described in above-mentioned Example 1. As a result, the fermented wine of the present invention made from the dry fruit of Acanthopanax sp. as main material was manufactured.

### Example 4

### Production of Fermented Wine by Using Dry Fruit as Main Material II

In order to prepare the fermented wine of the present invention, the dry Ogapi fruit was utilized as raw material.

Above all, the natural fruit of Acanthopanax was dried in the shade to prepare the dry fruit.

The resulting dry fruit was washed by using pure water and wiped off to remove moisture. To 4 kg of dry fruit, 22 L of pure water (5.5 L of pure water per 1 kg of dry fruit) was added, adjusted to 24° Brix by dissolving sugar and extracted through water heating for 5 hours at 50° C. primarily. Afterward, 22 L of pure water was added, adjusted to 24° Brix by dissolving sugar and again extracted through water heating for 5 hours at 50° C. secondarily. The extracted solution obtained above was filtrated to prepare approximately 45 L of the fruit extract (fermented solution). (the step for preparation of fermented solution) The same procedure was accomplished as described in above-mentioned Example 1. As a result, the fermented wine of the present invention made from the fruit of Acanthopanax sp. as main material was manufactured.

### Example 5

### Production of Fermented Wine by Using Dry Fruit as Main Material III

In order to prepare the fermented wine of the present invention, the dry Ogapi fruit was utilized as raw material.

In the step for preparation of fermented solution as described in above-mentioned Example 4, the water extract of Rosa davurica and the water extract Rhynchosia nolubilis prepared in Example 2, were added in the same content. Then, the same procedure was performed as described in Example 4. As a result, the fermented wine of the present invention made from the fruit of Acanthopanax sp. as main material was manufactured.

### INDUSTRIAL APPLICABILITY

As illustrated above, the present invention provides the fermented wine made from fruits of Acanthopanax sessiliflorus or Eleutherococcus senticosus, which exploits the Ogapi fruit for practical use even though it might be left alone or discarded so far and includes effective constituents more than typical wines

Therefore, the fermented wine of the present invention is a milder wine similar to grape wine in the characteristics and distinguished from other stronger liquors and sustains the pharmaceutical efficacy of Acanthopanax sp. Furthermore, the fermented wine of the present invention is a new application for Ogapi fruit which is so far left and discarded in the field and may result in economical effect to increase the benefits of farmhouses.

Those skilled in the art will appreciate that the conceptions and specific embodiments disclosed in the foregoing description may be readily utilized as a basis for modifying or designing other embodiments for carrying out the same purposes of the present invention.

Those skilled in the art will also appreciate that such equivalent embodiments do not depart from the spirit and scope of the invention as set forth in the appended claims.

1. Fermented wine made from fruit of deciduous shrub or latifoliate shrub in the family Araliaelata as main material.

2. The fermented wine according to claim 1, in which an extract of Rosa davurica and/or Rhynchosia nolubilis is added before fermentation.

3. A process for producing the fermented wine of claim 1, which comprises (A) step for preparation of fermented solution, in which 1˜20 L of pure water is added to 1 kg of crude fruit of deciduous shrub or latifoliate shrub in the family Araliaelata and adjusted to 10˜35° Brix by dissolving sugar; (B) step for fermentation, in which yeast is inoculated into said fermented solution and fermented at the range of 20˜30° C.; and (C) step for stopping the fermentation, in which said fermented solution is treated to stop the reaction.

4. The process for producing the fermented wine of claim 43, which comprises additionally (D) step for filtration, in which the fermented solution is filtrated after stopping the fermentation; and (E) step for maturation of the fermented solution filtrated above.

5. The process for producing the fermented wine according to claim 3 or claim 4, in which the fermented solution is at the range of 20˜30° Brix in said (A) step for preparation of fermented solution and is treated to stop the fermentation when the alcohol concentration of fermented solution reaches 5˜20% in said (C) step for stopping the fermentation.

6. The process for producing the fermented wine according to claim 3 or claim 4, in which said crude fruit is used as it is, reduced to powder before use, used only in the flesh after removing the core of fruit and squeezed to utilize juice only.

7. The process for producing the fermented wine according to claim 3 or 4, in which said shrub in the family Araliaelata is Acanthopanax sessiliflorous or Acanthopanax senticosus (or Eleutherococcus senticosus).

8. The process for producing the fermented wine according to claim 3 or claim 4, in which the water extract of Rosa davurica and the water extract of Rhynchosia nolobilis are added and preferably the water extract can be added in 0.05˜0.25 kg of Rosa davurica and 0.05˜0.25 kg of Rhynchosia nolubilis per 1 kg of dry weight of said crude fruit in said (A) step for preparation of fermented solution.

9. The process for preparing the fermented wine of claim 1, which comprises (A) step for drying fruit, in which crude fruit of deciduous shrub or latifoliate shrub in the family Araliaelata is dried; (B) step for preparation of fermented solution, in which 2˜30 L of pure water is added to 1 kg of dry fruit and adjusted to 10˜35° Brix by dissolving sugar; (C) step for fermentation, in which yeast is inoculated into said fermented solution and fermented at the range of 15˜30° C.; and (D) step for stopping the fermentation, in which said fermented solution is treated to stop the reaction.

10. The process for preparing the fermented wine according to claim 9, which comprises additionally (E) step for filtration, in which the fermented solution is filtrated after stopping the fermentation; and (F) step for maturation of fermented solution is filtrated above.

11. The process for preparing the fermented wine according to claim 9 or claim 10, in which the fermented solution is at the range of 20˜30° Brix in said (A) step for preparation of fermented solution and the fermented solution is treated to stop the reaction when the alcohol concentration of fermented solution reaches 5˜20% in said (C) step for stopping the fermention.

12. The process for preparing the fermented wine to claim 9 or claim 10, in which said crude fruit is used as it is, reduced to powder, used only in the flesh after removing the core of fruit, and squeezed to utilize only juice.

13. The process according to claim 9 or claim 10, in which said shrub in the family Araliaelata is Acanthopanax sessiliflorus or Acanthopanax senticosus (or Eleuntherococcus senticosus).

14. The process for preparing wine according to claim 9 or claim 10, in which the water extract of Rosa davurica and the water extract of are added and preferably the water extract can be added in 0.05˜0.25 kg of Rosa davudca and 0.05˜0.25 kg of Rhynchosia nolubilis per 1 kg of dry weight of said crude fruit in said (A) step for preparation of fermented solution.
